(19) United States
(12) Patent Application Publication
(10) Pub. No.: US 2005/0028850 A1
(43) Pub. Date: Feb. 10, 2005

(54) Dish washing machine

(76) Inventors: Hideyuki Nito, Osaka (JP); Kiyoyuki Suo, Osaka (JP); Hajime Suzuki, Osaka (JP)

Correspondence Address: RABIN & Berdo, PC, 1101 14TH STREET, NW, SUITE 500, WASHINGTON, DC, 20005, US

(21) Appl. No.: 10/912,184

(22) Filed: Aug. 6, 2004

(30) Foreign Application Priority Data
Aug. 8, 2003 (JP) 2003-290637

(51) Int. Cl. B08B 3/02

(52) U.S. Cl. 134/200; 134/199; 134/113; 134/93; 134/57 D

(57) ABSTRACT

A dish washing machine according to the present invention carries out a soaking step in a kitchen detergent course. In this step, a water supplying and draining FD1 for 25 seconds (water supplying for 4 seconds) is carried out (step E6), and thereafter a water supplying and draining FD2 for 30 seconds (water supplying for 22 seconds) is carried out(step E8). Thereby, a larger amount of wash water is flowed into a washing and draining pump, and foam left in a washing tank and foam stored in the washing and draining pump can be well discharged together with tap water supplied into the washing tank at a washing and draining time to the outside of the dish washing machine.

### BACKGROUND OF THE INVENTION

1. Field of the Invention The present invention relates to a dish washing machine capable of washing dishes by spraying a wash water toward dishes contained in a washing tank.

2. Description of Related Art

Usually, in a dish washing machine, a special detergent (mostly a powder detergent) is mixed with water stored in a washing tank to make a wash water, and by spraying the wash water toward dishes, the dishes can be washed (see, for example, Japanese Unexamined Patent Publication No.8-140919 (1996)). Plural nozzles are provided in the washing tank, and the wash water stored in the washing tank is sucked by a washing pump and sprayed through the plural nozzles toward the dishes. And the sprayed wash water is stored in the washing tank and sprayed through the plural nozzles toward the dishes again.

In the dish washing machine, the wash water is forcibly sprayed through the plural nozzles and at the same time the wash water in the washing tank is circulated for use. Accordingly, the detergent is apt to foam more in comparison with the case of washing the dishes by hands. Especially when few soils are attached to the dishes like the case in which the dishes once washed by hands are washed by the dish washing machine, the detergent is apt to foam more to form a large amount of foam in the washing tank. If a large amount of foam is formed in the washing tank, there occur such troubles as lowering of the washing ability and leaking of foam to the outside of the machine. Consequently, the special detergent for use in the dish washing machines is hard to foam in comparison with an ordinary kitchen detergent used for washing the dishes by hands.

It is convenient that the dishes can be washed with the kitchen detergent in the dish washing machine, for example, when a user has forgotten to buy the special detergent. However, if the kitchen detergent is used in the conventional dish washing machine, a large amount of foam is formed.

When the large amount of foam is formed in the washing tank, the foam is sucked into the washing pump thus to be stored in the washing pump and water cannels communicated with the washing pump (for example, water supply pipes connecting the washing pump and the nozzles and the like) so that sometimes the wash water cannot flow smoothly.

### SUMMARY OF THE INVENTION

The present invention has been made in such backgrounds, and a main object of the present invention is to provide a dish washing machine capable of effectively removing foam formed in the dish washing machine.

Another special object of the present invention is to provide an improved dish washing machine capable of washing dishes with a kitchen detergent and preventing a large amount of foam from being formed at the time of washing the dishes with the kitchen detergent.

A dish washing machine according to the present invention includes a foam removing means for removing foam formed when a washing course using the kitchen detergent is carried out.

The foam removing means can be realized by a means for carrying out water supply and draining for a long time. When the water supply and draining is carried out for a long time, the foam left in a washing tank and the foam stored in a pump can be discharged to the outside of the dish washing machine together with water supplied into the washing tank at the time of the water supply and draining. Therefore, the foam formed in the dish washing machine can be effectively removed away.

The foam removing means may be an operation temporarily stopping means.

By stopping spraying water toward the dishes for a predetermined time, the foam in the washing tank can well go out of existence in course of time. Therefore, the foam formed in the dish washing machine can be effectively removed away.

The foam removing means may be a means for extending a rinsing step.

When the rinsing step is extended, the foam in the washing tank can be well removed away. Therefore, the foam formed in the dish washing machine can be effectively removed away.

Further, the foam removing means may be a means for increasing a drain amount and forcibly discharging the foam to the outside of the dish washing machine.

### BRIEF DESCRIPTION OF THE DRAWINGS

FIG. 1 is a perspective view of a dish washing machine according to one embodiment of the present invention seen obliquely from its front side.

FIG. 2 is a sectional view of the dish washing machine sectioned along a vertical plane in a direction of the depth of the dish washing machine and seen from the right side.

FIG. 3 is a front view, seen from the front side, of the dish washing machine with an upper door and a lower door being removed.

FIG. 4 is a sectional view of the dish washing machine sectioned along a horizontal plane in a direction of the depth of the machine and seen from above.

FIG. 5 is a side view of a washing tank seen from the right side.

FIG. 6 is a block diagram showing an electric arrangement of the dish washing machine.

FIG. 7 is a flow chart showing a flow of control by a control section in a special detergent course.

FIG. 8 is a flow chart showing a flow of control by the control section in a kitchen detergent course.

FIG. 9 is a flow chart showing a flow of control by the control section in a soaking step in the kitchen detergent course.

FIG. 10 is a flow chart showing a flow of control by the control section in a washing step in the kitchen detergent course.

FIG. 11 is a flow chart showing a flow of control by the control section in a first to third rinsing in the kitchen detergent course.

FIG. 12 is a flow chart showing a flow of control by the control section in a heat-rinsing in the kitchen detergent course.

FIG. 13 is a flow chart showing a flow of control by the control section in a rinsing step when a rinsing extending operation is carried out.

### DESCRIPTION OF THE PREFERRED EMBODIMENTS

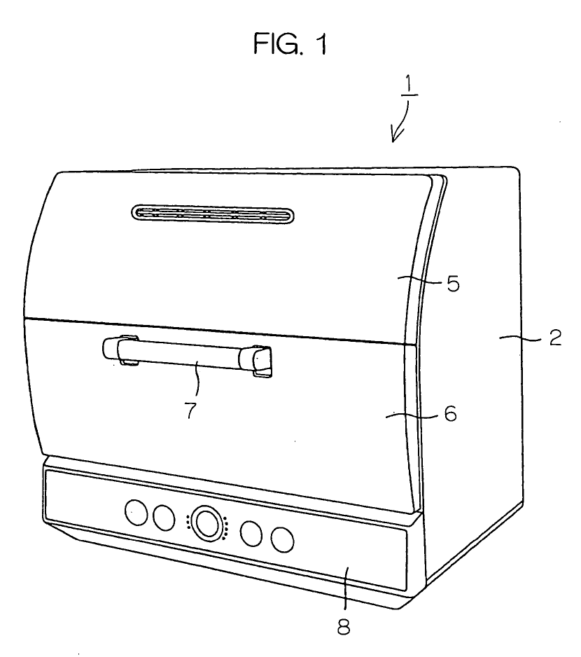

FIG. 1 is a perspective view of a dish washing machine 1 according to one embodiment of the present invention seen obliquely from its front side.

Referring to FIG. 1, the dish washing machine 1 has an outer shape of a substantially rectangular parallelepiped box-shaped body 2. The box-shaped body 2 is so formed that its length from the front end to the rear end (depth) is shorter than its length from the right end to the left end (width).

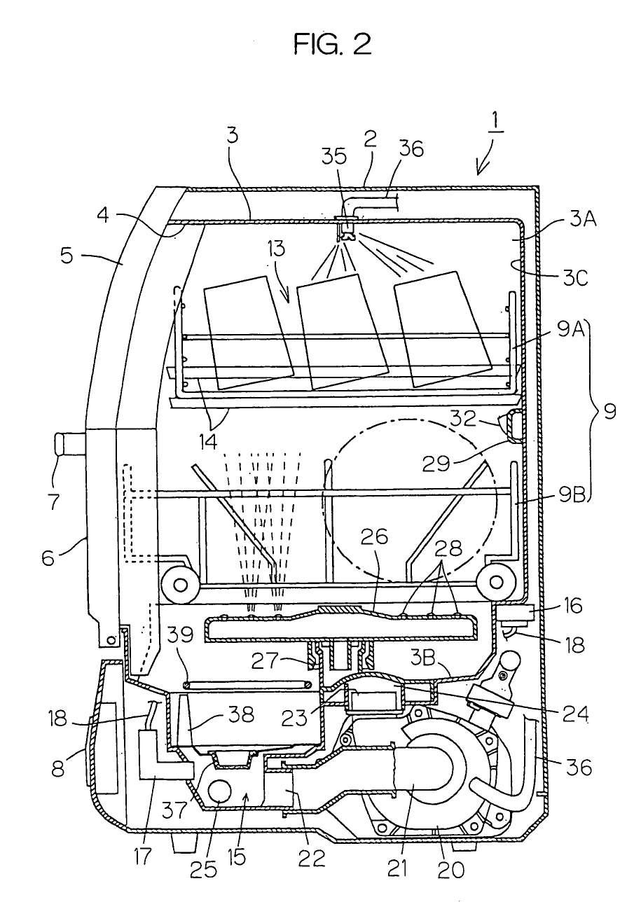

Disposed within the box-shaped body 2 is a washing tank 3 for containing dishes, and an opening 4 is provided in front of the washing tank 3 (see FIG. 2). The opening 4 can be covered with two doors (an upper door 5 and a lower door 6) pivotally attached to the box-shaped body 2. The upper door 5 can cover substantially the upper half of the opening 4 and the lower door 6 can cover substantially the lower half of the opening 4. The upper door 5 is pivotally movable in a forward and upward direction, while the lower door 6 is pivotally movable in a forward and downward direction. When the upper door 5 and the lower door 6 are closed, the opening 4 is covered so that the washing tank 3 is water-tightly sealed.

Provided in a middle portion along the width of the lower door 6 of an upper end portion thereof is a handle 7, which a user holds at the time of opening the lower door 6. When the user holds the handle 7 and pulls the same forward, the lower door 6 is pivotally moved in the forward and downward direction. The upper door 5 is movable in an interlocking manner with the lower door 6. When the lower door 6 is pivotally moved in the forward and downward direction, the upper door 5 is pivotally moved in the forward and upward direction in the interlocking manner with the lower door 6, and the opening 4 is widely opened.

In a lower portion of the front surface of the box-shaped body 2, an operation display panel 8 is provided for setting operations of the dish washing machine 1 (operation course and the like) and displaying operation states and the like.

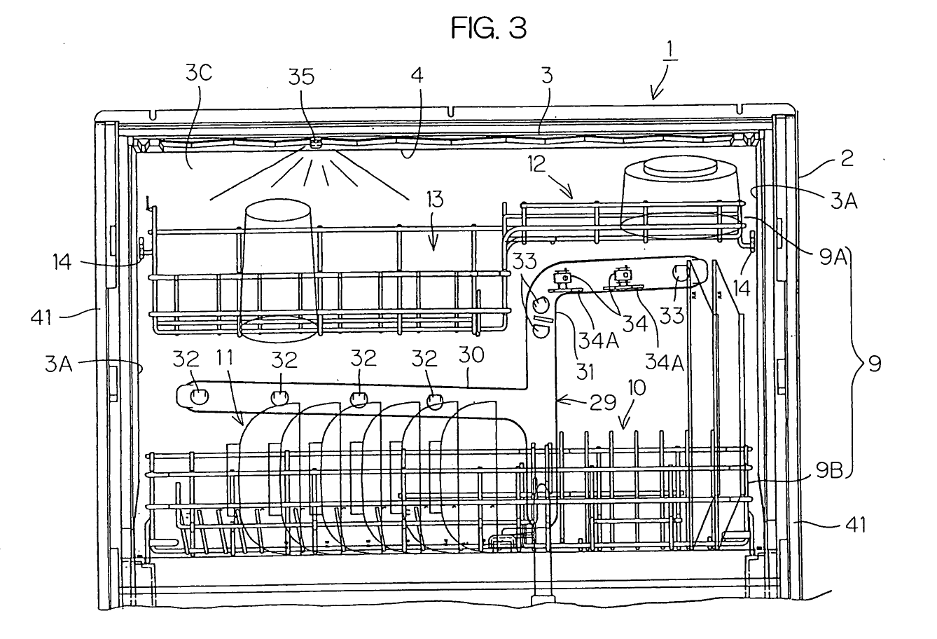

FIG. 2 is a sectional view of the dish washing machine 1 sectioned along a vertical plane in a direction of the depth of the machine 1 and seen from the right side. FIG. 3 is a front view, seen from the front side, of the dish washing machine 1 with the upper door 5 and the lower door 6 being removed. In FIG. 3, the lower part of the dish washing machine 1 is omitted.

Referring to FIGS. 2 and 3, in the washing tank 3, two dish baskets 9 (an upper basket 9A and a lower basket 9B) for supporting dishes to be washed are disposed with a predetermined space therebetween in a vertical direction. Each of the upper basket 9A and the lower basket 9B is slidable in a direction of the depth. With the upper door 5 and the lower door 6 being opened, each of the baskets 9A and 9B can be forwardly pulled out through the opening 4, so that the dishes can be easily put into and out of the dish washing machine 1.

A right side part (in a range of about a third from the right end) of the lower basket 9B is a large plate containing section 10 in which relatively large plates or platters such as dinner plates or salad plates can be contained in an upright state. Further, a part from the central portion to the left side of the lower basket 9B (in a range of about two thirds from the left end) is a bowl containing section 11 in which bowls such as soup bowls or salad dishes can be contained in the laterally upright state.

A right side part (in a range of about a third from the right end) of the upper basket 9A is a small bowl containing section 12 for containing small bowls. Further, a part from the central portion to the left side of the upper basket 9A (in a range of about two thirds from the left end) is a glass containing section 13 for containing glasses, teacups, or the like. In the small bowl containing section 12, four bowls in total can be contained in such a manner that two bowls are arranged right and left in each of two (the front and rear) rows. In the glass containing section 13, twelve glasses in total can be contained in such a manner that four glasses are arranged from right to left in each of three (the front, middle and rear) rows. The bowls to be contained in the small bowl containing section 12 and the glasses or teacups to be contained in the glass containing section 13 are set with their bottoms up.

The large plates or the like to be contained in the large plate containing section 10 require larger vertical spaces than the soup bowls or the like to be contained in the bowl containing section 11 require. On the other hand, the small bowls to be contained in the small bowl containing section 12 require smaller vertical spaces than the glasses or the like to be contained in the glass containing section 13 require. Therefore, in this embodiment, the small bowl containing section 12 is disposed above the large plate containing section 10, the glass containing section 13 is disposed above the bowl containing section 11, and the glass containing section 13 is disposed lower by a degree than the small bowl containing section 12. As a result, the dishes can be efficiently contained in the upper basket 9A and the lower basket 9B. Further, in vacant spaces in peripheral portions or the like of the upper basket 9A and the lower basket 9B, small dishes can be contained in the upright state.

In an upper portions of right and left inner side surfaces 3A, 3B of the washing tank 3, vertically spaced two pairs of rails 14 are provided in parallel with a predetermined spaces therebetween (in FIG. 2, only left side rails 14 are shown). Each pair of rails 14 engages with right and left side edge portions of the upper basket 9A and thereby supports the upper basket 9A so as to be slidable in forward and rearward directions. With this structure, a height of the upper basket 9A can be doubly changed over, depending upon which one of the vertically provided two pairs of rails 14 the right and left side edge portions of the upper basket 9A engage with. When the right and left side edge portions of the upper basket 9A engage with the upper pair of rails 14 and the upper basket 9A is held at a higher position, a rather large space can be defined above the large plate containing section 10, so that even especial large plates can be well contained in the large plate containing section 10.

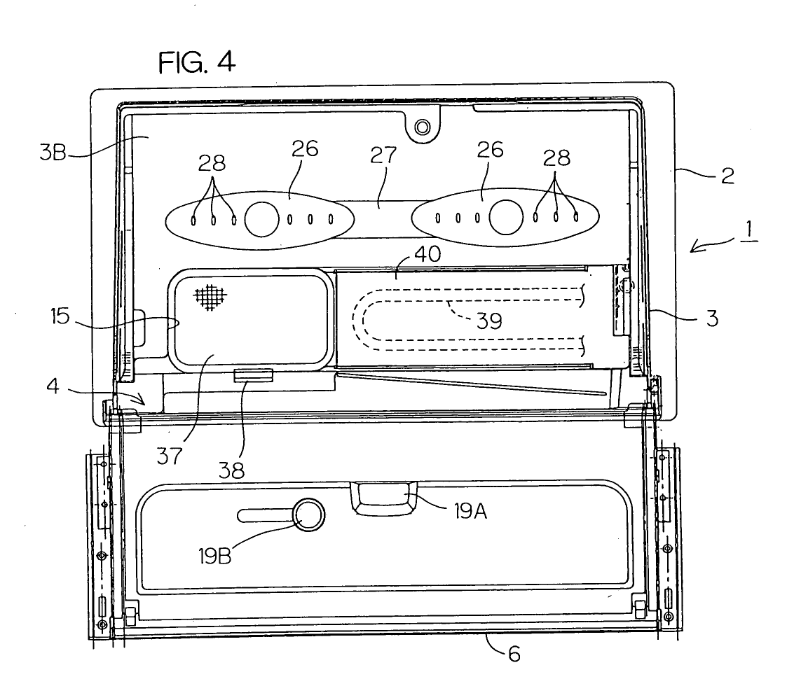

FIG. 4 is a sectional view of the dish washing machine 1 sectioned along a horizontal plane in a direction of the depth of the machine 1 and seen from above, in which the lower door 6 is opened.

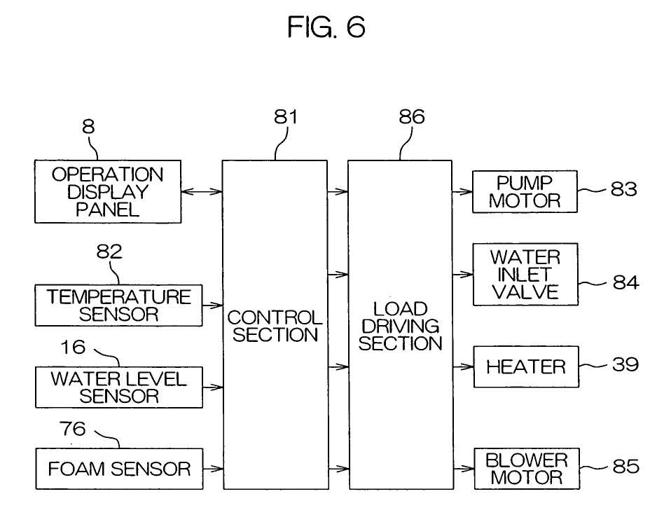

Referring to FIGS. 2 to 4, a water storing section 15 for storing a wash water is provided at front and left portion, lower by a degree, of a bottom 3B of the washing tank 3. A tap water can be supplied into the washing tank 3, for example, from a water supply installation or a hot water supply installation from outside of the dish washing machine 1. The tap water supplied into the washing tank 3 is stored in the lower portion of the washing tank 3 including the water storing section 15. The tap water from the water supply installation and the tap water (hot water) from the hot water supply installation is supplied into the washing tank 3 by opening or closing a water inlet valve 84 (see FIG. 6). In a case of supplying the hot water from the hot water supply installation through the water inlet valve 84 into the washing tank 3, such an operation is set by an operation display panel 8, for example. By throwing a detergent into the washing tank 3, the detergent is mixed with the tap water supplied into the washing tank 3 and thereby the wash water used for washing the dishes is obtained.

A water level of the wash water (or the tap water) stored in the washing tank 3 can be detected by a water level sensor (pressure sensor) 16 provided in a lower rear portion of the washing tank 3. An air trap 17 is communicated with the water storing section 15, and the air trap 17 and the water level sensor 16 are connected by an air hose 18. With such a structure, an air pressure in the air trap 17 changes in accordance with the change of the water level in the washing tank 3. Consequently, by detecting the air pressure change in the air trap 17 by the water level sensor 16, the water level of the wash water stored in the washing tank 3 can be detected.

Substantially in the middle portion of the inner surface of the lower door 6 (the surface on the washing tank 3 side when the lower door 6 is closed), a recess for containing a (generally powder-type) special detergent (a special detergent containing section 19A) is formed. On the left side of the special detergent containing section 19A, a recess for containing a (generally liquid-type) kitchen detergent (a kitchen detergent containing section 19B) is formed (see FIG. 4). In this dish washing machine 1, two different operation courses can be carried out. One is a course in which, with the special detergent being contained in the special detergent containing section 19A, the special detergent is mixed with the tap water supplied into the washing tank 3 and the dishes are washed with thus obtained wash water (a special detergent course), and another is a course in which, with the kitchen detergent being contained in the kitchen detergent containing section 19B, the kitchen detergent is mixed with the tap water supplied into the washing tank 3 and the dishes are washed with thus obtained wash water (a kitchen detergent course).

The special detergent containing section 19A and the kitchen detergent containing section 19B respectively have different shapes. That is, the special detergent containing section 19A is substantially rectangular in plan view, while the kitchen detergent containing section 19B is substantially circular in plan view. When the lower door 6 is opened, the openings of the special detergent containing section 19A and the kitchen detergent containing section 19B respectively are upward, and therefore the special detergent and the kitchen detergent can be contained therein. When the lower door 6 is closed after putting the special detergent in the special detergent containing section 19A or the kitchen detergent in the kitchen detergent containing section 19B, the special detergent in the special detergent containing section 19A or the kitchen detergent in the kitchen detergent containing section 19B drops into the washing tank 3 and is mixed with the tap water supplied into the washing tank 3.

In a case of washing the dishes in the kitchen detergent course, the amount of the kitchen detergent to be used is preferably about 5 ml. There are neutral, alkalescent and acidulant kitchen detergent. If the amount of the detergent is about 5 ml, the dishes can be sufficiently washed with any kind of detergent.

Provided below the washing tank 3 (behind the water storing section 15) is a washing and draining pump 20 for circulating the wash water in the washing tank 3 at the time of dish washing, and draining the wash water in the washing tank 3. Though not shown in FIG. 2, the inside of the washing and draining pump 20 is divided into a washing pump chamber and a draining pump chamber, and the washing pump chamber and the draining pump chamber respectively are provided with a washing impeller and a drain impeller each rotatably driven by a pump motor 83 (see FIG. 6).

An inlet opening 21 of the washing pump chamber is connected to a circulation opening 22 formed in a rear wall of the water storing section 15, while an outlet opening 23 of the washing pump chamber is connected to a water channel 24 elongated in a direction of the width below the washing tank 3. The water channel 24 is connected to a rotary nozzle arm and a fixed nozzle arm mentioned below. When the pump motor 83 is normally rotated, a rotation of the washing impeller in the washing pump chamber makes the wash water sucked from the water storing section 15 through the circulation opening 22 into the washing pump chamber. The wash water is then supplied through the outlet opening 23 into the water channel 24. The wash water supplied under pressure thorough the water channel 24 is sprayed, through the rotary nozzle arm and the fixed nozzle arm, toward the dishes in the washing tank 3. The wash water sprayed through the rotary nozzle arm and the fixed nozzle arm is stored again in a bottom portion of the washing tank 3, and sucked from the water storing section 15 through the circulation opening 22 into the washing and draining pump 20 (washing pump chamber). In such a manner, the wash water stored in the water storing section 15 is circulated within the dish washing machine 1 to be used for washing the dishes.

Further, an inlet opening of the draining pump chamber is connected to a drain opening 25 formed in a left side wall of the water storing section 15, while an outlet opening of the draining pump chamber is connected to a drain channel (not shown) communicated with the outside of the dish washing machine 1. When the pump motor 83 is reversely rotated, a rotation of the drain impeller in the draining pump chamber makes the wash water sucked from the water storing section 15 through the drain opening 25 into the draining pump chamber. The wash water is drained through the drain channel to the outside of the dish washing machine 1.

At the bottom of the washing tank 3, two rotary nozzle arms 26 are disposed right and left for spraying the wash water upwardly from below the lower basket 9B. The two rotary nozzle arms 26 have substantially elliptical long shapes respectively and are supported by a common nozzle base 27 so as to be rotated in a horizontal surface about the longitudinally central portion thereof. The nozzle base 27 is communicated with the water channel 24.

Plural (for example, six) nozzles 28 are provided in an upper surface of each rotary nozzle arm 26. The wash water supplied from the washing and draining pump 20 through the water channel 24 and the nozzle base 27 to each rotary nozzle arm 26 is upwardly sprayed through the nozzles 28 of each rotary nozzle arm 26. When the wash water is sprayed through the nozzles 28 of each rotary nozzle arm 26, a reaction force is generated to each rotary nozzle arm 26, and by this reaction force, each rotary nozzle arm 26 are rotated with spraying the wash water through the nozzles 28. Thereby, the dishes disposed above each rotary nozzle arm 26 are uniformly sprayed with the wash water and can be well washed.

On a rear surface (inner surface) of the washing tank 3, a fixed nozzle arm 29 is provided for spraying the wash water from between the upper basket 9A and the lower basket 9B. The fixed nozzle arm 29 is elongated upwardly from the lower end thereof, and then, at the midway, branched into a first arm 30 and a second arm 31. The lower end of the fixed nozzle arm 29 is communicated with the water channel 24.

The first arm 30 is branched leftward at a position slightly lower than the glass containing section 13 of the upper basket 9A and elongated substantially in the horizontal direction near to the left end of the rear surface 3C. The first arm 30 is provided with nozzles 32 for upwardly spraying the wash water toward glasses put in the most rear row (third row) of the glass containing section 13. The number of the nozzles 32 is equal to the number (four) of glasses containable in the most rear row of the glass containing section 13. Each nozzle 32 is in correspondence with each of four glasses contained in the most rear row of the glass containing section 13, so that the wash water can be sprayed toward the inside of each corresponding glass.

The second arm 31 is elongated further above the branched position of the first arm 30 and bent rightward at a position slightly lower than the small bowl containing section 12, to be elongated substantially in the horizontal direction near to the right end of the rear surface 3C. The second arm 31 is provided with plural (for example, three) nozzles 33 for upwardly spraying the wash water toward the small bowls contained in the small bowl containing section 12. The second arm 31 is further provided with plural (for example, two) impeller-type nozzles 34 for downwardly spraying the wash water toward the large plates contained in the large plate containing section 10. In this impeller-type nozzle 34, an impeller rotates in accompany with the wash water spraying, so that the wash water can be sprinkled in wide range. With the use of these impeller-type nozzles 34, the wash water can be sprayed to the upper portions of large plates which are hard to be sprayed with the wash water from the right side rotary nozzle arm 26.

On the ceiling surface 3D (inner surface) of the washing tank 3, a ceiling nozzle 35 for downwardly spraying the wash water is provided substantially just above the central portion of the glass containing section 13. The ceiling nozzle 35 is connected through a water supply pipe 36 to the washing chamber of the washing and draining pump 20. Therefore, when the pump motor 83 is normally rotated and thereby the washing impeller in the washing pump chamber is rotated, the wash water sucked from the water storing section 15 through the circulation opening 22 into the washing pump chamber is supplied through the water supply pipe 36 to the ceiling nozzle 35, and then downwardly sprayed from the ceiling nozzle 35. The wash water from the ceiling nozzle 35 is diffused right and left and sprayed to positions near just below the ceiling nozzle 35 and positions on the rear side of the ceiling nozzle 35. As a result, the outer surfaces of glasses contained in the second and third rows in the glass containing section 13 (see FIG. 2).

A mesh-type garbage filter 37 is removably attached to an upper edge portion of the water storing section 15. This garbage filter 37 catches garbage removed from the dishes during washing, so that garbage can be prevented from falling into the water storing section 15. An upwardly elongated handle 38 is provided at the center of the front end of the garbage filter 37. Grasping this handle 38, a user can easily attach or remove the garbage filter 37.

The dish washing machine 1 has a function of drying washed dishes. In a portion from the front center to the right end of the bottom surface 3B of the of the washing tank 3 (on the right side of the water storing section 15) a loop-shaped heater 39 is provided for heating the wash water in the washing tank 3 at a washing time and heating air in the washing tank 3 at a drying time. A metal heater cover 40 having plural through holes (not shown) is provided above the heater 39.

Vertically elongated sound insulation seals 41 respectively are attached to right and left end edge portions (on the outer side than the washing tank 3) of the front surface of the box-shaped body 2 (see FIG. 3). An operation of the sound insulation seals 41 prevents noises generated in the dish washing machine 1, when the dish washing machine 1 is operated, from leaking to the outside of the dish washing machine.

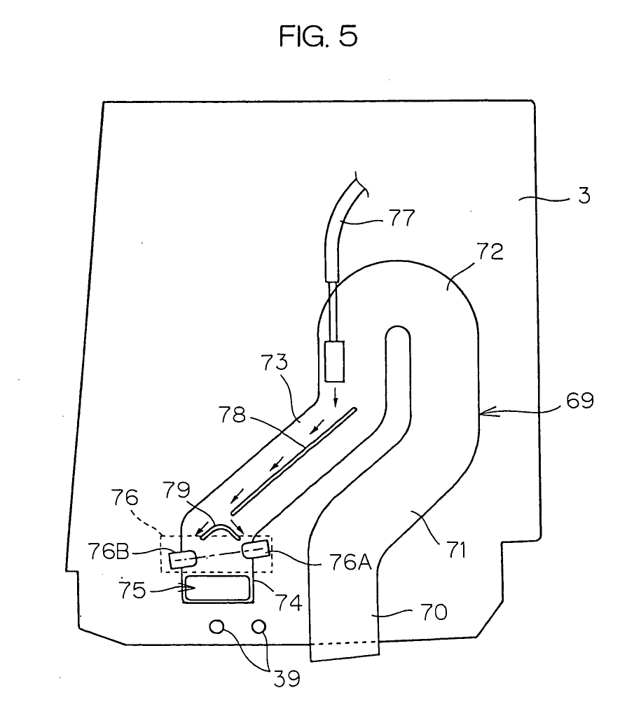

FIG. 5 is a side view of the washing tank 3 seen from the right side and shown schematically for illustrating the inside of an air trunk member 69.

Referring to FIG. 5, the air trunk member 69 is attached to a right side wall of the washing tank 3 from outside. The air trunk member 69 constitutes an air trunk through which an outside air is supplied from a blower (not shown) into the washing tank 3. The air trunk member 69 is hollow member and comprises a root portion 70 upwardly extending from a middle lower portion of the right side of the washing tank 3, a first inclined portion 71 extending rearwardly obliquely and upwardly from the upper end of the root portion 70, a curved portion 72 upwardly extending from the upper end of the first inclined portion 71 and then curved substantially in U-shape to extend downwardly, a second inclined portion 73 obliquely downwardly extending toward a user from the lower end of the curved portion 72, and a terminating portion 74 downwardly extending from the lower end of the second inclined portion 73 to be connected to a blower opening 75 provided in the front lower portion of the right side wall of the washing tank 3.

The lower end of the root portion 70 of the air trunk member 69 is connected to the blower. With a blower motor 85 (see FIG. 6) provided in the blower being driven, the outside air of the dish washing machine 1 is sucked into the air trunk member 69. The outside air sucked into the dish washing machine 1 passes through the air trunk member 69 and is supplied through the blower opening 75 into the washing tank 3. The blower opening 75 is disposed slightly above the heater 39. The air supplied through the blower opening 75 to the bottom portion of the washing tank 3 is heated by the heater 39.

In the terminating portion 74 of the air trunk member 69, a foam sensor 76 for detecting foam formed in the washing tank 3. The foam sensor 76 is, for example, an optical sensor which comprises a light emitting portion 76A attached to the rear surface of the terminating portion 74 for radiating light forwardly (somewhat downward forwardly), and a light receiving portion 76B attached to the front surface of the terminating portion 74 so as to oppose to the light emitting portion 76A for receiving the light radiated from the light emitting portion 76A. When a large amount of foam is formed in the washing tank 3, the foam comes through the blower opening 75 into the air trunk member 69 (into the terminating portion 74). And when the foam coming into the air trunk member 69 reaches an optical axis of the light radiated by the light emitting portion 76A, the light is interrupted by the foam and an amount of the light received by the light receiving-portion 76B decreases. Thus, on the basis of the change of the amount of the light detected by the light receiving portion 76B, state of the form generated in the washing tank 3 can be detected.

A distal end of a branched hose 77 branched from the drain channel is connected to the end, on the second inclined portion 73 side, of the curved portion 72 of the air trunk member 69. At the draining time, a part of the wash water drained from the draining pump chamber of the washing and draining pump 20 is introduced through the branched hose 77 into the air trunk member 69, and falls from the curved portion 72 down to the second inclined portion 73. Within the second inclined portion 73 of the air trunk member 69, provided is a first rib 78 extending in the same direction with the extension of the second inclined portion 73. The first rib 78 extends from the upper end to the lower end of the second inclined portion 73, so that the wash water falling from the branched hose 77 down into the second inclined portion 73 is downwardly led along the first rib 78.

At the lower end of the second inclined portion 73, a second rib 79 in a substantially inverted V shape is disposed with a predetermined space from the lower end of the first rib 78. It is so constructed that the wash water downwardly led along the first rib 78 falls down on a top portion of the second rib 79, and therefore, the wash water falling down on the second rib 79 is distributed forwardly and rearwardly. The front end and the rear end of the second rib 79 are disposed respectively adjacent to the light emitting portion 76A and the light receiving portion 76B of the foam sensor 76. It is so constructed that the wash water flowing on the second rib 79 is splashed on the light emitting portion 76A and the light receiving portion 76B. With such a structure, at the draining time, soils like foam attached to the light emitting portion 76A and the light receiving portion 76B can be washed away by the wash water supplied into the air trunk member 69.

FIG. 6 is a block diagram showing an electric arrangement of the dish washing machine 1.

Referring to FIG. 6, an operation of the dish washing machine 1 is controlled by a control section 81 including, for example, a microcomputer. The operation display panel 8 is connected to the control section 81 so as to input and output data. Besides, signals from the water level sensor 16 and the foam sensor 76 can be inputted into the control section 81.

In this embodiment, in the bottom portion of the washing tank 3 (for example, below the heater 39), a temperature sensor 82 is provided for detecting temperature of the wash water (or the tap water) stored in the washing tank 3. The temperature sensor 82 includes a thermistor, and it is so constructed that signals from the temperature sensor are also inputted into the control section 81.

Further, connected to the control section 81 are the pump motor 83, the water inlet valve 84, the heater 39 and the blower motor 85 through a load driving section 86. By controlling a driving of the heater 39 on the basis of a signal from the temperature sensor 82, a temperature of the wash water (or the tap water) stored in the washing tank 3 can be controlled. The control section 81 can rotate (normally and reversely) the pump motor 83 dually at high speed (for example, 3000 rpm) and at low speed (for example, 2300 rpm). However, rotation speeds of the pump motor 83 are not limited to the two speeds but may be changed over among more than three speeds.

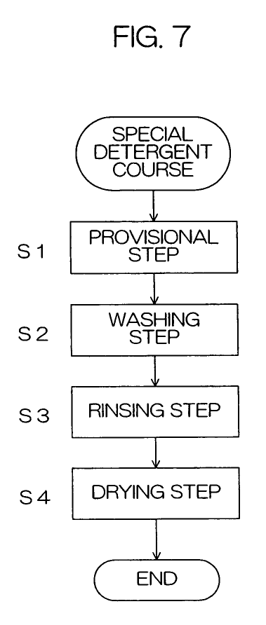

FIG. 7 is a flow chart showing a flow of control by the control section 81 in the special detergent course, in which it is so set that hot water is supplied into the washing tank 3 from the hot water supply installation.

Referring to FIG. 7, in the special detergent course, the control section 81 carries out a provisionary step in which, at the beginning, with opening the water inlet valve 84 for a predetermined time to supply the tap water (the hot water) into the washing tank 3, and the pump motor 83 is reversely rotated to drain the tap water stored in the washing tank 3 (in the water storing section 15) to the outside of the dish washing machine 1 (step S1).

In this dish washing machine 1, the hot water is supplied from the outside hot water supply installation into the washing tank 3, and the supplied hot water in the washing tank 3 is mixed with the special detergent to make the wash water, so that the dishes can be sprayed with the wash water to be sterilized and washed (high temperature washing). In a case of carrying out the high temperature washing, the tap water at ordinary temperature is supplied when a hot water supply from the hot water supply installation into the washing tank 3 is started, and then the temperature of the tap water gradually rises. Therefore, by carrying out the provisional step, the tap water at ordinary temperature supplied into the washing tank 3 at the time of starting the hot water supply can be drained, and the hot water stored in the washing tank 3 can be at sufficiently high temperature.

After the provisional step is ended, the control section 81 carries out a washing step in which the water inlet valve 84 is opened for a predetermined time to supply the tap water into the washing tank 3, and then by normally rotating the washing and draining pump 20, the wash water stored in the washing tank 3 is sprayed toward the dishes (step S2). After that, a rinsing step is carried out (step S3). In the rinsing step, the washing and draining pump 20 is reversely rotated thereby to drain the wash water (or the tap water) stored in the washing tank 3 once, and thereafter the water inlet valve 84 is opened to supply the tap water into the washing tank 3; then the washing and draining pump 20 is normally rotated thereby to spray the tap water stored in the washing tank 3 toward the dishes, and this step is repeated three times (first rinsing, second rinsing and third rinsing); and the heater 39 is driven to heat the tap water stored in the washing tank 3 thereby to operate a step in which the heated tap water is sprayed toward the dishes (heat-rinsing).

In the first rinsing and the second rinsing, the washing and draining pump 20 is normally rotated at low speed for 30 seconds and thereafter normally rotated at high speed for 30 seconds. In the third rinsing, the washing and draining pump 20 is normally rotated at high speed for 60 seconds.

After the rinsing step is ended, the control section 81 carries out a drying step in which, with driving the blower motor 85 to introducing the outside air into the washing tank 3, the air in the washing tank 3 is heated by the heater 39 thereby to dry the dishes (step S4).

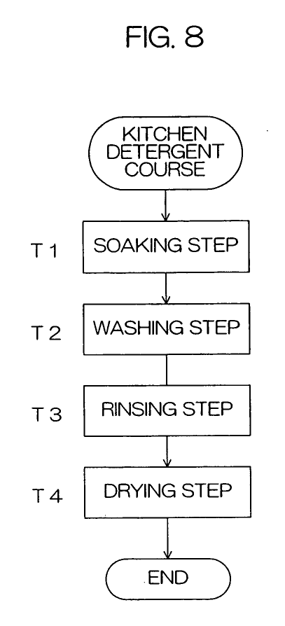

FIG. 8 is a flow chart showing a flow of control by the control section 81 in the kitchen detergent course.

Referring to FIG. 8, in the kitchen detergent course, the control section 81, to begin with, carries out a soaking step in which the water inlet valve 84 is opened for a predetermined time to supply the tap water into the washing tank 3 and the supplied tap water is mixed with the kitchen detergent to make the wash water, thereby to operate a step to spray the wash water stored in the washing tank 3 toward the dishes and leave the dishes for a predetermined time for plural times repeatedly (step T1). In the kitchen detergent course, carrying out the soaking step before the washing step prevents forming a large amount of the foam in the washing tank 3.

In the kitchen detergent course, the soaking step is started without carrying out the provisional step. Unlike the special detergent, the kitchen detergent generally has a lowered washing ability when mixed with high temperature tap water to make the wash water. In the kitchen detergent course, since the provisional step is not carried out, the temperature of the hot water stored in the washing tank 3 can be relatively low even in the case of high temperature washing has been set. This can restrict lowering of the washing ability of the kitchen detergent. As a result, the dishes can be washed better.

Further, the kitchen detergent is liquid, unlike the special detergent. Therefore, if the provisional step is carried out as in the special detergent course, the kitchen detergent supplied into the washing tank 3 is apt to be wholly drained to the outside of the dish washing machine 1 during the provisional step. However, since the kitchen detergent course does not include the provisional step, the kitchen detergent supplied into the washing tank 3 is prevented from being wholly drained to the outside of the dish washing machine 1.

When the soaking step is ended, the control section 81 carries out a washing step for spraying the wash water stored in the washing tank 3 toward the dishes (step T2). This washing step corresponds to the washing step in the special detergent course (step S2 in FIG. 7). When the washing step is ended, the control section 81 carries out a rinsing step (step T3), and thereafter carries out a drying step (step T4). A control operation of the control section 81 in the drying step is the same as that in the special detergent course.

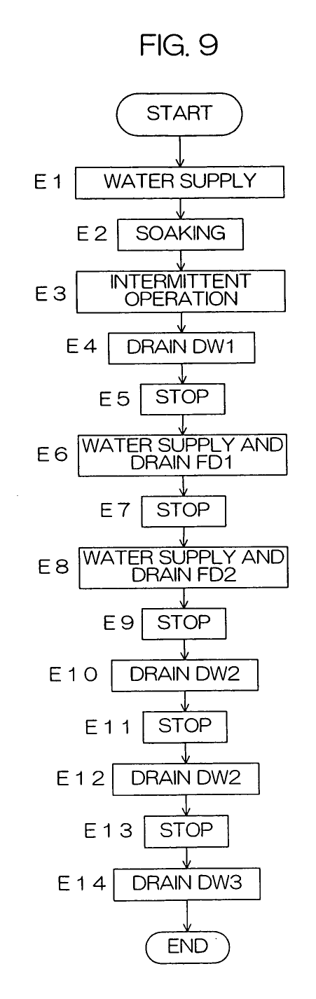

FIG. 9 is a flow chart showing flow of control by the control section 81 in the soaking step in the kitchen detergent course.

Referring to FIG. 9, in the soaking step, the control section 81 first opens the water inlet valve 84 to supply the tap water in the washing tank 3 (step E1) and thereby the tap water and the kitchen detergent are mixed to make the wash water. And when the tap water is supplied to a predetermined level in the washing tank 3, the control section 81 repeats plural times a process of spraying the wash water stored in the washing tank 3 toward the dishes and leaving the dishes for a predetermined time, thereby carrying out the soaking (step E2).

When the soaking is ended, the control section 81 repeats two times an operation of normally rotating the washing and draining pump 20 for 0.5 second and then stopping the washing and draining pump 20 for 0.5 second, thereby carrying out an intermittent operation for 2 seconds (step E3). Thereafter, the control section 81 reversely rotates the washing and draining pump 20 at high speed for 15 seconds thereby to drain the wash water in the washing tank 3 (draining DW1) (step E4), then stops the washing and draining pump 20 for 2 seconds (step E5) and thereafter carrying out the water supply and draining for 25 seconds (water supply and draining FD1) (step E6). In this water supply and draining FD1, the draining is carried out by reversely rotating the washing and draining pump 20 at high speed for 10 seconds after reversely rotating the washing and draining pump 20 at low speed for 15 seconds, and at the same time, the water inlet valve 84 is opened to supply the water for the last 4 seconds.

When the water supply and draining FD1 is ended, the control section 81 stops the washing and draining pump 20 for 2 seconds (step E7), and thereafter carries out the water supply and draining for 30 seconds (water supply and draining FD2) (step E8). In this water supply and draining FD2, the draining is carried out by reversely rotating the washing and draining pump 20 at low speed for 30 seconds and at the same time, the water inlet valve 84 is opened to supply the water for the first 22 seconds.

When the water supply and draining FD2 is ended, the control section 81 stops the washing and draining pump 20 for 2 seconds (step E9), and thereafter carries out the draining (draining DW2) of the wash water in the washing tank 3 by reversely rotating the washing and draining pump 20 at low speed for 15 seconds (step E10). Thereafter, the control section 81 stops the washing and draining pump 20 for 2 seconds (step E11), and then carries out the draining DW2 again by reversely rotating the washing and draining pump 20 at low speed for 15 seconds (step E12). Thereafter, the control section 81 stops the washing and draining pump 20 for 2 seconds (step E13), and then carries out the draining (draining DW3) of the wash water in the washing tank 3 by reversely rotating the washing and draining pump 20 at high speed for 15 seconds (step E14).

However, controls of steps E8 to E11 can be omitted. Further, the draining DW3 (step E14) may be carried out only when the draining DW2 of step E12 is insufficient.

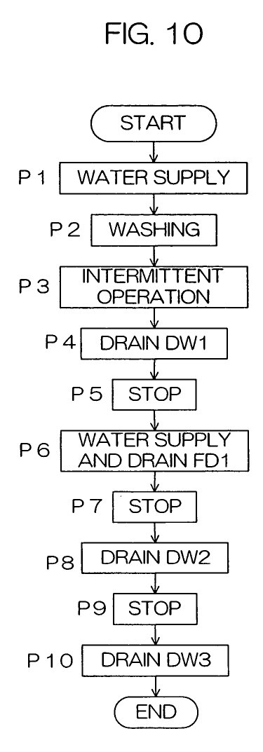

FIG. 10 is a flow chart showing a flow of control by the control section 81 in a washing step in the kitchen detergent course.

Referring to FIG. 10, in the washing step, the control section 81 first opens the water inlet valve 84 to supply the water into the washing tank 3 (step P1). And when the water is supplied to a predetermined level in the washing tank 3, the control section 81 carries out the washing by spraying the wash water stored in the washing tank 3 toward the dishes (step P2).

When the washing is ended, the control section 81 repeats two times an operation of normally rotating the washing and draining pump 20 for 0.5 second and then stopping the washing and draining pump 20 for 0.5 second, thereby carrying out an intermittent operation for 2 seconds (step P3). Thereafter, the control section 81 reversely rotates the washing and draining pump 20 at high speed for 15 seconds thereby to drain the wash water in the washing tank 3 (draining DW1) (step P4), then stops the washing and draining pump 20 for 2 seconds (step P5) and thereafter carries out the water supply and draining (water supply and draining FD1) for 25 seconds (step P6). An operation in this water supply and draining FD1 is the same as that of the water supply and draining FD1 in the step E6 in FIG. 9.

When the water supply and draining FD1 is ended, the control section 81 stops the washing and draining pump 20 for 2 seconds (step P7), and thereafter carries out the draining (draining DW2) of the wash water in the washing tank 3 by reversely rotating the washing and draining pump 20 at low speed for 15 seconds (step P8). Thereafter, the control section 81 stops the washing and draining pump 20 for 2 seconds (step P9), and then carries out the draining (draining DW3) of the wash water in the washing tank 3 by reversely rotating the washing and draining pump 20 at high speed for 15 seconds (step P10).

However, the draining DW3 (step P10) may be carried out only when the draining DW2 of step P8 is insufficient.

In the washing step (step S2 in FIG. 7) in the special detergent course, controls similar to those operated in the abovementioned washing step in the kitchen detergent course. That is, the water supply and draining carried out in the washing step in the special detergent course is only the water supply and draining FD1 for 25 seconds (water supply for 4 seconds) (step P6 in FIG. 10). On the other hand, as abovementioned, in the soaking step in the kitchen detergent course, after the water supply and draining FD1 for 25 seconds (water supply for 4 seconds) is carried out (step E6 in FIG. 9), the water supply and draining FD2 for 30 seconds (water supply for 22 seconds) is further carried out (step E8 in FIG. 9). In such a manner, in the kitchen detergent course, the water supply and draining is carried out for a longer time than in the special detergent course, so that a larger amount of the wash water is supplied into the washing and draining pump 20 and drained therefrom to the outside of the dish washing machine 1. As a result, the foam left in the washing tank 3 and the foam stored in the washing and draining pump 20 can be well discharged to the outside of the dish washing machine 1 together with the tap water supplied into the washing tank 3 at the water supply and draining time. Therefore, the foam formed in the dish washing machine 1 can be effectively removed away.

However, the dish washing machine 1 according to the present invention is not limited to a structure in which the water supply and draining time is long in the soaking step in the kitchen detergent course, but the water supply and draining time may be set long in another step (for example, the washing step or the rinsing step).

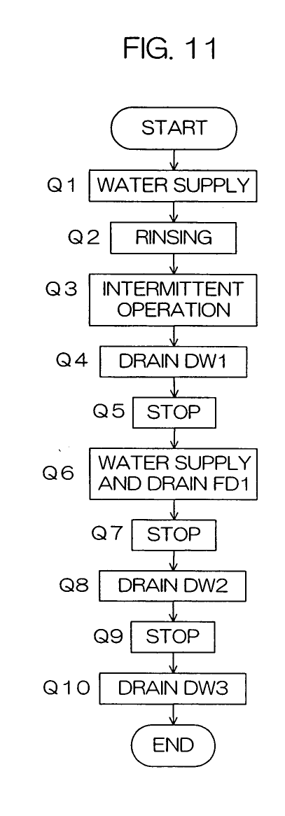

FIG. 11 is a flow chart showing a flow of control by the control section 81 in the first rinsing to the third rinsing. In the first rinsing to the third rinsing, controls by the control section 81 are respectively performed in the similar flow as shown in FIG. 11.

Referring to FIG. 11, In the first to the third rinsing, the control section 81 first opens the water inlet valve 84 to supply the water into the washing tank 3 (step Q1). And when the water is supplied to a predetermined level in the washing tank 3, the control section 81 carries out a rinsing by spraying the tap water stored in the washing tank 3 toward the dishes (step Q2). In the first rinsing, the washing and draining pump 20 is normally rotated at low speed for 30 seconds and thereafter normally rotated at high speed for 30 seconds. On the other hands, in the second rinsing and the third rinsing, the washing and draining pump 20 is normally rotated at low speed for 30 seconds and then normally rotated at high speed for 150 seconds, and thereafter, stopped for 59 seconds and then intermittently operated for 2 seconds (that is, an operation for normally rotating the washing and draining pump 20 for 0.5 second and stopping for 0.5 second is repeated two times).

In such a manner, in a rinsing time of step Q2 in the second rinsing and the third rinsing, the washing and draining pump 20 is stopped for 59 seconds (about 1 minute), so that the foam in the washing tank 3 can go out of existence in course of time. Further, an intermittent operation is carried out for 2 seconds, so that the foam left in a corner of the water surface (adjacent to an inner surface of the washing tank 3) and the like can be dissolved into the tap water in the washing tank 3. Therefore the foam in the washing tank 3 can be better removed away. As a result, the foam formed in the dish washing machine 1 can be effectively removed away.

When the rinsing is ended, the control section 81 repeats two times an operation for normally rotating the washing and draining pump 20 for 0.5 second and stopping the same for 0.5 second, thereby carrying out the intermittent operation for 2 seconds (step Q3). Thereafter, the control section 81 reversely rotates the washing and draining pump 20 for 15 seconds at high speed to drain the tap water in the washing tank 3 (draining DW1) (step Q4), and stops the washing and draining pump 20 for 2 seconds (step Q5) and then carries out the water supply and draining for 25 seconds (water supply and draining FD1) (step Q6). An operation in this water supply and draining FD1 is the same as the water supply and draining FD1 of step E6 in FIG. 9 and in step P6 in FIG. 10.

When the water supply and draining FD1 is ended, the control section 81 stops the washing and draining pump 20 for 2 seconds (step Q7) and then reversely rotates the washing and draining pump 20 at low speed for 15 seconds thereby to drain the tap water in the washing tank 3 (draining DW2) (step Q8). Thereafter, the control section 81 stops the washing and draining pump 20 for 2 seconds (step Q9) and then reversely rotates the washing and draining pump 20 at high speed for 15 seconds thereby to drain the tap water in the washing tank 3 (draining DW3) (step Q10).

However, the draining DW3 (step Q10) may be carried out only when the draining DW2 of step Q8 is insufficient.

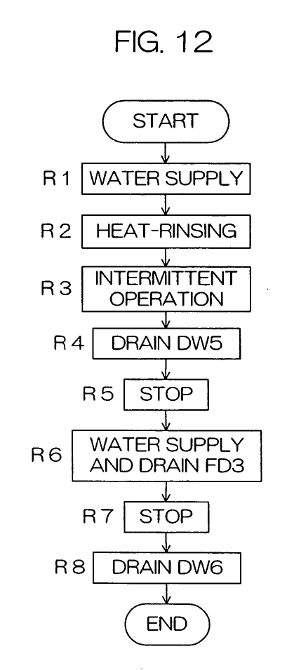

FIG. 12 is a flow chart showing a flow of control by the control section 81 in a heat-rinsing in the kitchen detergent course.

Referring to FIG. 12, in the heat-rinsing, the control section 81 first opens the water inlet valve 84 to supply the water in the washing tank 3 (step R1). And when the water is supplied to a predetermined level in the washing tank 3, the control section 81 drives the heater 39 to heat the tap water stored in the washing tank 3, and the heated tap water is sprayed toward the dishes, thereby carrying out the heat-rinsing (step R2).

When the heat-rinsing is ended, the control section 81 repeats two times an operation of normally rotating the washing and draining pump 20 for 0.5 second and then stopping the washing and draining pump 20 for 0.5 second, thereby carrying out the intermittent operation for 2 seconds (step R3). Thereafter, the control section 81 reversely rotates the washing and draining pump 20 at high speed for 5 seconds thereby to drain the tap water in the washing tank 3 (draining DW5) (step R4), then stops the washing and draining pump 20 for 2 seconds (step R5) and thereafter carrying out the water supply and draining for 60 seconds (water supply and draining FD3) (step R6). In this water supply and draining FD3, the draining is carried out by reversely rotating the washing and draining pump 20 at high speed for 10 seconds, reversely rotating the same at low speed for 10 seconds, stopping the same for 3 seconds, reversely rotating the same at low speed for 5 seconds, stopping the same for 2 seconds, reversely rotating the same at low speed for 10 seconds, stopping the same for 4 seconds, reversely rotating the same at low speed for 6 seconds, stopping the same for 2 seconds, and reversely rotating the same at low speed for 8 seconds in this order, and at the same time, the water inlet valve 84 is opened to supply the water for 5 seconds after 18 seconds have passed from the start of the water supply and draining FD3. Further, in the water supply and draining FD3, during the period from the time when 15 seconds have passed from the start of the water supply and draining FD3 to the time when the same is ended, an operation for rotating the blower motor 85 for 0.3 second and then stopping the same for 2.7 seconds is repeated plural times.

When the water supply and draining FD3 is ended, the control section 81 stops the washing and draining pump 20 for 2 seconds (step R7) and thereafter and reversely rotates the same at high speed for 30 seconds, thereby carrying out the draining of the wash water in the washing tank 3 (draining DW6) (step R8).

However, the draining DW6 (step R8) may be carried out only when the draining in the water supply and draining FD3 of step R6 is insufficient.

It has been described that, at the washing time, by normally rotating the pump motor 83, the wash water sucked from the water storing section 15 through the circulation opening 22 into the washing and draining pump 20 (the washing pump chamber) is supplied through the water supply pipe 36 to the ceiling nozzle 35, and then downwardly sprayed from the ceiling nozzle 35. In addition to that, at the draining time, even when the pump motor 83 is reversely rotated and the washing impeller in the wishing pump chamber is rotated in a direction opposite to a direction of the rotation thereof at the washing time, the wash water is supplied under pressure into the water supply pipe 36 from the washing pump chamber, though a water pressure then is extremely low in comparison with a water pressure at the washing time. Therefore, the wash water, though in a small amount, is also sprayed from the ceiling nozzle 35 at the draining time.

In this embodiment, the washing and draining pump 20 is reversely rotated at high speed for a predetermined time in the draining time (step E4, P4, Q4 or R4) carried out after each step of spraying the water (the wash water or the tap water) toward the dishes contained in the washing tank 3 (soaking, washing, first rinsing to third rinsing, heat-rinsing or the like). Therefore, at the draining time, a large amount of water is supplied from the washing pump chamber of the washing and draining pump 20 into the water supply pipe 36. Therefore, it is possible to discharge the foam stored in the water supply pipe 36 through the ceiling nozzle 35 to be dissolved into the water in the washing tank 3, and suck this water by the washing and draining pump 20 to be discharged to the outside of the dish washing machine 1. As a result, the foam formed in the dish washing machine 1 can be effectively removed away.

Further, when the washing and draining pump 20 is rotated at high speed, a large amount of the wash water is supplied from the draining pump chamber of the washing and draining pump 20 through the branched hose 77 to the foam sensor 76 side. Consequently, it is possible to discharge the foam stored in the branched hose 77 and the air trunk member 69 through the blower opening 75 to be dissolved into the water in the washing tank 3, and suck this water by the draining pump chamber of the washing and draining pump 20 to be discharged to the outside of the dish washing machine 1. As a result, the foam formed in the dish washing machine 1 can be further effectively removed away.

In the rinsing step (the first rinsing to the third rinsing and the heat-rinsing), it is detected whether more than a predetermined amount of foam is formed in the washing tank 3 or not, and when more than the predetermined amount of foam is formed, an operation of extending the rinsing time (a rinsing time extending operation) can be carried out.

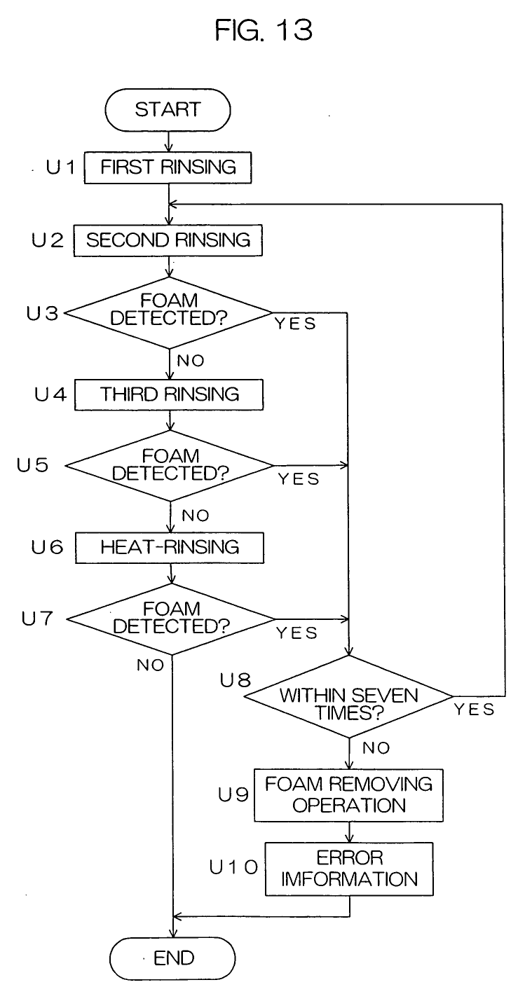

FIG. 13 is a flow chart showing a flow of control by the control section 81 in the rinsing step when the rising time extending operation is carried out.

Referring to FIG. 13, when the rising time extending operation is carried out, the control section 81 carries out the first rinsing and the second rinsing (step U1, U2), and thereafter judges whether a predetermined amount of foam is formed in the washing tank 3 in the second rinsing (NO at step U3). And when it is detected that more than the predetermined amount of foam is formed in the washing tank 3 in the second rinsing (YES at step U3), the control section 81 judges whether the repetition time number of the second rinsing is within 7 (step U8). And when it is judged that the repetition time number of the second rinsing is within 7 (YES at step U8), the control section 81 carries out the second rinsing again (step U2).

As a result of repeating the second rinsing in such a manner, when the repetition time number becomes over 7 (NO at step U8), the control section 81 repeats plural times an operation for supplying the water into the washing tank 3, then intermittently driving the washing and draining pump 20 to intermittently spray the tap water in the washing tank 3 through the nozzles 28, 32, 33, 35, and thereafter draining the tap water in the washing tank 3, thereby carrying out an operation of removing the foam in the washing tank 3 (foam removing operation) (step U9). And when the foam removing operation is ended, the control section 81 gives an error information by a display on the operation display panel 8 or sound (step U10) and ends the operation.

When it is not detected that more than the predetermined amount of the foam is formed in the washing tank 3 in the second rinsing (NO at step U3), the control section 81 carries out the third rinsing (step U4) and judges whether it is detected that the predetermined amount of foam is formed in the washing tank 3 in the third rinsing (step U5). And when it is detected that the predetermined amount of foam is formed in the washing tank 3 in the third rinsing (YES at step US), the control section 81 judges whether the repetition time number of the second rinsing is within 7 (step U8). And when it is judged that the repetition time number of the second rinsing is within 7 (YES at step U8), the control section 81 carries out the second rinsing again (step U2). On the other hand, when the repetition time number of the second rinsing is over 7 (NO at step U8), the control section 81 carries out the foam removing operation (step U9) and then gives the error information (step U10) and ends the operation.

When it is not detected that more than the predetermined amount of foam is formed in the washing tank 3 in the third rinsing (NO at step US), the control section 81 carries out the heat-rinsing (step U6) and judges whether it is detected that more than the predetermined amount of foam is formed in the washing tank 3 in the heat-rinsing (step U7). And when it is detected that more than a predetermined amount of foam is formed in the washing tank 3 in the heat-rinsing (YES at step U7), the control section 81 judges whether the repetition time number of the second rinsing is within 7 (step U8). And when it is judged that the repetition time number is within 7 (YES at step U8), the control section 81 carries out the second rinsing again (step U2). On the other hand, when the repetition time number of the second rinsing is over 7 (NO at step U8), the control section 81 carries out the foam removing operation (step U9) and then gives the error information (step U10) and ends the operation.

When it is not detected that more than the predetermined amount of foam is formed in the washing tank 3 in the heat-rinsing while the second rinsing is repeated 7 times at the maximum as abovementioned (NO at step U7) the rinsing step is ended.

In this embodiment, when it is detected by the foam sensor 76 that more than the predetermined amount of foam is formed in the washing tank 3 in the rinsing step in the kitchen detergent course, the rinsing step is extended, so that the foam in the washing tank 3 can be well removed away. As a result, the foam formed in the dish washing machine 1 can be efficiently removed away.

Further, when an amount of the foam in the washing tank 3 is not below the predetermined amount even if the rinsing step is extended till the repetition time number of the second rinsing becomes over 7, the foam in the washing tank 3 is removed away by carrying out the foam removing operation. As a result, the foam formed in the dish washing machine 1 can be more effectively removed away.

The present invention is not limited to the abovementioned description of the embodiment.

For example, means for spraying the wash water (or the tap water) toward the dishes contained in the dish basket 9 are not limited to the rotary nozzle arm 26, the fixed nozzle arm 29 or the ceiling nozzle 35, but may be a structure including nozzles provided on the right and left side surfaces of the washing tank 3 and the like.

This application corresponds to Japanese Patent Application No. 2003-290637 filed with the Japanese Patent Office on Aug. 8, 2003, the disclosure of which is incorporated herein by reference.

1. A dish washing machine capable of carrying out a special detergent course for washing dishes with a special detergent and a kitchen detergent course for washing the dishes with a kitchen detergent, including
a washing tank,
a water spraying step carrying out means for carrying out a water spray step for spraying water toward dishes contained in the washing tank,
a draining step carrying out means for carrying out a draining step for draining water in the washing tank after the water spray step, and
a water supplying step carrying out means for carrying out a water supplying step for supplying water into the washing tank in the way of the draining step,
in which, in the kitchen detergent course, the water supplying step carrying out means carries out the water supplying step for a longer time than in the special detergent course.

2. A dish washing machine as set forth in claim 1, in which, since the water supplying step carrying out means carries out the water supplying step for a longer time, the time of water supply and draining carried out at the same time also becomes longer, so that foam in the washing tank can be removed away.

3. A dish washing machine capable of carrying out a kitchen detergent course for washing dishes with a kitchen detergent, including
a washing tank,
a rinsing step carrying out means for carrying out a rinsing step for spraying water toward dishes contained in the washing tank to rinse the dishes, and
a foam removing means for causing foam formed in the washing tank to go out of existence in course of time by stopping spraying the water toward the dishes for a predetermined time while carrying out the rinsing step in the kitchen detergent course.

4. A dish washing machine as set forth in claim 3, including
a foam detecting means for detecting whether more than a predetermined amount of foam is formed in the washing tank or not, and
a rinsing step extending means for extending the rinsing step when the foam detecting means detected that more than the predetermined amount of foam is formed in the washing tank while the rinsing step carrying out means is carrying out the rinsing step.

5. A dish washing machine as set forth in claim 4, in which
the rinsing step carries out a rinsing operation for spraying water toward the dishes contained in the washing tank to rinse the dishes and thereafter draining water in the washing tank for predetermined number of times, and
the rinsing step extending means increases a carrying out time number of the rinsing operation based on a detection by the foam detecting means that more than the predetermined amount of foam is formed in the washing tank during the rinsing step,
the dish washing machine further including a foam removing operation carrying out means for carrying out a foam removing operation for removing the foam formed in the washing tank when the carrying out time number of the rinsing operation increased by the rinsing step extending means becomes over a predetermined number.

6. A dish washing machine including
a washing tank,
a water spraying step carrying out means for carrying out a water spray step for spraying water toward dishes contained in the washing tank,
a draining step carrying out means for carrying out a draining step for draining the water in the washing tank to the outside of the dish washing machine,
a washing and draining pump for sucking the water in the washing tank thereinto provided with a spray outlet opening for discharging the sucked water in the water spraying step and a drain outlet opening for discharging the sucked water in the draining step, in which when the water is discharged from the drain outlet opening in the draining step, a less amount of water, than the amount of water discharged from the drain outlet opening, is also discharged from the spray outlet opening, and
a driving control means for controlling a driving of the washing and draining pump so that the discharge amount of the washing and draining pump can be increased in the draining step carried out after the water spraying step.

7. A dish washing machine as set forth in claim 6, in which the driving control means increases the discharge amount of the washing and draining pump by reversely rotating the washing and draining pump at high speed.

8. A dish washing machine as set forth in claim 7, including
a foam sensor for detecting whether more than a predetermined amount of foam is formed in the washing tank or not, and
a sensor washing water channel communicated with the drain outlet opening for leading water drained in the draining step to the foam sensor side thereby to wash the foam sensor.
